(19) United States
(12) Patent Application Publication
(10) Pub. No.: US 2025/0010367 A1
(43) Pub. Date: Jan. 9, 2025

(54) Roller Surface Hardening

(71) Applicant: Matthews International Corporation, Pittsburgh, PA (US)

(72) Inventors: Thomas HACKFORT, Ahaus-Altstätte (DE); Stefan TERBILLE, Vreden (DE); Harald BARTSCH, Dorsten-Rhade (DE)

(21) Appl. No.: 18/707,620

(22) PCT Filed: Nov. 9, 2022
(86) PCT No.: PCT/US2022/049391

§ 371 Date: May 6, 2024

Related U.S. Application Data
(60) Provisional application No. 63/277,477, filed on Nov. 9, 2021.

(51) Int. Cl. B22F 3/18; B21B 27/02; C04B 35/52; C04B 35/56; C04B 35/622; H01M 4/04

(52) U.S. Cl. CPC B22F 3/18; B21B 27/02; C04B 35/52; C04B 35/5626; C04B 35/62222; H01M 4/0435; B22F 2998/10; C04B 2235/95

(57) ABSTRACT

The present disclosure relates to rollers such as nip rollers and calendering rollers with a coating and a method of applying the coating. More specifically, the present disclosure relates to a nip roller or a calender roller with a hardening layer applied to the surface to prevent damage from contaminants.

### CROSS-REFERENCE TO RELATED APPLICATIONS

This application claims priority to U.S. Provisional Application Ser. No. 63/277,477 filed on Nov. 9, 2021, the entirety of which is incorporated by reference herein.

### FIELD

The present disclosure relates to rollers such as nip rollers and calendering rollers with a coating and a method of applying the coating. More specifically, the present disclosure relates to a nip roller or a calender roller with a hardening layer applied to the surface to prevent damage from contaminants.

The precise formation of films, which are alternatively referred to in the art as sheets, webs, or substrates, is an industry challenge. Precise formation of films is especially challenging where significant levels of pressure must be applied in actual production environments. The rollers that exert the pressure must be formed precisely so that they themselves form films having dimensions and surface characteristics that fall within the required design parameters.

Additionally, there is the problem of dirt, particles, and other impurities that are naturally present in production environments. Even with care and cleaning, it is inevitable that one or more contaminant particles will eventually reside on the surfaces of the rollers. When particles are deposited on the surface of rollers that contact each other during machine operation, the particles are compressed between the rollers during machine operation. When such particles are compressed between the rollers, they exert large concentrated forces on the surface of the rollers. This is known as contact fatigue, and is evidenced by fatigue pitting on both surfaces of the rollers that contact each other.

Contact fatigue negatively impacts the quality of products that are formed because the rollers have surface defects. There is a need to prevent the formation of pits, surface deformation, and other undesirable microstructural features that accumulate on the surface of rollers in working production environments.

Considering the need for a precise and uniform surface of the films, even small damage caused by contaminants can adversely affect the functioning of the films when they are assembled into final products and placed into service. Thus, there is a need to increase the hardness of the rollers to prevent damage occurring from the concentrated pressure applied by the contaminants. One method of increasing the hardness to prevent damage from occurring to the rollers include applying a hardening layer. Conventional methods of applying a hardness coating to rollers include jet spraying of tungsten carbide and electroplating chromium. However, jet sprayed tungsten carbide and electroplated chromium films can themselves have micrometer scale defects such as pinholes. In addition to avoiding these drawbacks, it would be beneficial to construct coatings that provide the rollers an even higher hardness and therefore performance.

### SUMMARY

There is provided a calender roller apparatus including a hardening layer formed by one of chemical vapor deposition (CVD) or plasma assisted chemical vapor deposition (PACVD) of diamond like coating (DLC) and physical vapor deposition (PVD) of tungsten carbide for damage reduction from dirt, particles, and other impurities.

In one embodiment, the techniques described herein relate to a method of forming a dry electrode film, the method including: contacting a surface hardened roller with a dry electrode or dry electrode precursor powder, imparting at least one force on the dry electrode or the dry electrode precursor powder with the surface hardened roller in order to form the dry electrode film.

In some embodiments, the techniques described herein relate to a method, wherein the surface hardened roller includes a hardening layer of at least diamond like coating or tungsten carbide.

In some embodiments, the techniques described herein relate to a method, wherein the thickness of the hardening layer is 1 μm to about 300 μm.

In some embodiments, the techniques described herein relate to a method, wherein the surface hardened roller includes at least one underlayer.

In some embodiments, the techniques described herein relate to a method, wherein the underlayer is included of one of tungsten carbide, a diamond like coating, copper, or chrome.

In some embodiments, the techniques described herein relate to a method, wherein the underlayer has a thickness of about 1 μm to about 300 μm.

In some embodiments, the techniques described herein relate to a method, wherein the surface hardened roller is at least one of a nip roller or a calendering roller.

In one embodiment, the techniques described herein relate to a system including: a roller including: a hardening layer positioned on the surface of the roller.

In some embodiments, the techniques described herein relate to a system, wherein the hardening layer is included of one of tungsten carbide, chrome, or a diamond like coating.

In some embodiments, the techniques described herein relate to a system, wherein the thickness of the hardening layer is about 1 μm to about 300 μm.

In some embodiments, the techniques described herein relate to a system, further including an underlayer positioned between the surface of the roller and the hardening layer, wherein: the underlayer is included of one of tungsten carbide, a diamond like coating, copper, or chrome.

In some embodiments, the techniques described herein relate to a system, wherein the underlayer has a thickness of about 1 μm to about 300 μm.

### DRAWINGS

Aspects, features, benefits and advantages of the embodiments described herein will be apparent with regard to the following description, appended claims, and accompanying drawings where:

FIG. 1 illustrates a diagram of the calender rollers used for the creation of the films in accordance with an embodiment.

FIG. 2 illustrates a diagram of a cross-sectional view of the calender rollers with a hardening layer applied in accordance with an embodiment.

FIG. 3 illustrates the method of applying a diamond like coating by chemical vapor deposition in accordance with an embodiment.

FIG. 4 illustrates the method of applying tungsten carbide by physical vapor deposition in accordance with an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

This disclosure describes a calender roller apparatus including a hardening layer for protection against damage from contaminants and impurities, as well as methods for applying the hardening layers. Through coating the calender rollers by chemical vapor deposition of a diamond like coating and physical vapor deposition of tungsten carbide, the hardness of the rollers can be increased to prevent damage caused by high pressures exerted on the rollers by contaminants and impurities.

As used herein “uncoated roller” means a roller which has not had a hardening layer applied. For example, one embodiment of an uncoated roller includes a roller which does not include a tungsten carbide layer or diamond like coating.

As described herein, “diamond like coating” or “DLC” means a thin film comprised of crystallized carbon. For example, one embodiment of a diamond like coating includes a synthetically produced hardening layer by method of chemical vapor deposition of carbon.

As used herein “contaminants” means a small impurity present on the roller during the creation of the films capable of damaging either the film or the rollers when a pressure is applied. Contaminants are not limited and are frequently dependent on the production environment where the rollers reside, and examples of contaminants include one or more of dirt particles, metal particles, metal shavings, electrode particles, inorganic particles, conductive particles, insulating particles, uncured polymer particles, or cured polymer particles.

As used herein, “low pressure environment” means an environment having a pressure that is low enough to achieve the deposition via the selected process. For example, one embodiment of a low pressure environment includes a sub-atmospheric pressure environment.

FIG. 1 illustrates a diagram 100 of the powder mill 100 including the calender rollers 101 used for the creation of the films in accordance with an embodiment. The powder enters through a hopper 102 above the calender rollers, where it is compressed into a film.

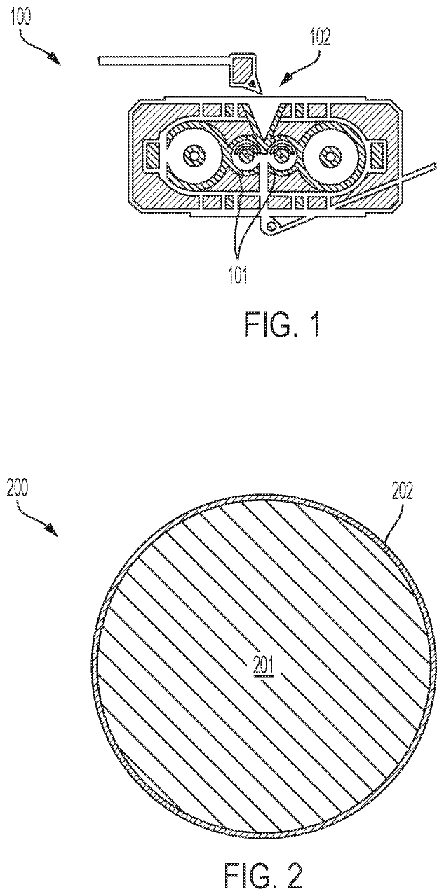

FIG. 2 illustrates a diagram 200 of a cross-sectional view of the calender rollers 201 with a hardening layer 202 applied in accordance with an embodiment. The hardening layers 202 used may include any material effective to calender films known to one or ordinary skill in the art. In some embodiments, the hardening layer 202 is selected from one of chrome, tungsten carbide, and a diamond like coating. In some embodiments, the hardening layer 202 is positioned on the surface of the calender roller 201.

In some embodiments, the thickness of the hardening layer 202 is about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm, about 100 μm, about 150 μm, about 200 μm, about 250 μm, about 300 μm, or any range between any two or more of the preceding values, for example about 1 μm to about 300 μm, about 10 μm to about 300 μm, about 100 μm to about 300 μm, 1 μm to about 200 μm, about 10 μm to about 200 μm, or about 100 μm to about 200 μm.

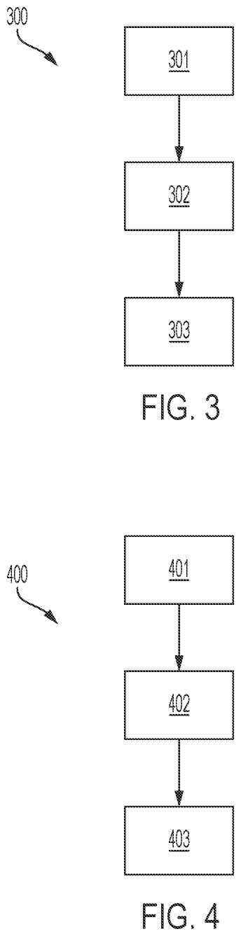

FIG. 3 illustrates the method 300 of depositing a diamond like coating by chemical vapor deposition in accordance with an embodiment. In this method, the uncoated roller is placed within a low pressure environment in block 301. Within the low pressure environment, the uncoated roller is exposed to volatile precursors in block 302, including but not limited to one or more of methane (CH₄) and carbon monoxide (CO). These precursors react on the surface of the uncoated rollers to form a diamond like coating. While the deposition of diamond like coating is described above by chemical vapor deposition, it is understood that variants of CVD can also be used, such as plasma assisted chemical vapor deposition (PACVD). Once the deposition is complete, the roller can be removed from the low pressure environment in block 303.

The thickness of the deposited diamond like coating is about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm, about 100 μm, about 150 μm, about 200 μm, about 250 μm, about 300 μm, or any range between any two or more of the preceding values, for example about 1 μm to about 300 μm, about 10 μm to about 300 μm, about 100 μm to about 300 μm, 1 μm to about 200 μm, about 10 μm to about 200 μm, or about 100 μm to about 200 μm

FIG. 4 illustrates a method 400 of depositing a hardening layer, for example tungsten carbide, in accordance with an embodiment. In this method, the uncoated roller is placed within a low pressure environment in block 401. Within the low pressure environment, the uncoated roller is exposed to volatile precursors in block 402. The volatile precursors are not limited and include one or more of tungsten hexachloride (WCl₆) with hydrogen (H₂) and methane (CH₄), or alternatively WCL₆ with H₂ and methanol (C₃OH). This achieves the deposition of a tungsten carbide coating. While the deposition of tungsten carbide is described above by chemical vapor deposition, it is understood that variants of CVD can also be used, such as plasma assisted chemical vapor deposition (PACVD). Once the deposition is complete, the roller can be removed from the low pressure environment in block 403.

The thickness of the deposited hardening layer is about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm, about 100 μm, about 150 μm, about 200 μm, about 250 μm, about 300 μm, or any range between any two or more of the preceding values, for example about 1 μm to about 300 μm, about 10 μm to about 300 μm, about 100 μm to about 300 μm, 1 μm to about 200 μm, about 10 μm to about 200 μm, or about 100 μm to about 200 μm

In certain embodiments, an underlayer provides additional protection or surface adhesion. The underlayer is not limited and can include one or more of chrome, diamond like coating (DLC), tungsten carbide (WC), or copper (Cu).

In some embodiments, the underlayer has a thickness of about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm, about 100 μm, about 150 μm, about 200 μm, about 250 μm, about 300 μm, or any range between any two or more of the preceding values, for example about 1 μm to about 300 μm, about 10 μm to about 300 μm, about 100 μm to about 300 μm, 1 μm to about 200 μm, about 10 μm to about 200 μm, or about 100 μm to about 200 μm

The composition and microstructure of the diamond like coating can be adjusted depending on requirements for surface hardness, chemical resistance, toughness, and other desired properties. Examples include of such diamond like coatings include one or more of form ta-C (tetrahedrally bound hydrogen-free amorphous carbon), form a-C:H (an amorphous carbon with hydrogen, form a-C:H:Me (Me=W, Ti, metal-doped amorphous carbon with hydrogen), form a-C:H:Si (a Si-doped amorphous carbon with hydrogen), form a-C:H:X (a non-metal-doped amorphous carbon with hydrogen), form a-C:Me (Me=Ti, metal-doped hydrogen-free amorphous carbon), form ta-C:H (a tetrahedrally bound amorphous carbon with hydrogen).

The uses of the rollers of the disclosure, including nip rollers or calendering rollers, is not limited. In one embodiment, the rollers including nip rollers or calendering rollers are surface hardened by at least one of diamond like coating or tungsten carbide and used to process electrode materials. In some embodiments, the electrode materials that are processed are one or more of an anode or a cathode, and the anode or the cathode can each individually be a dry anode or cathode that is formed with substantially no solvent. These various electrodes are collectively referred to as dry electrodes, though they can have varying compositions, microstructure, and functionality.

In one embodiment, there is a method of forming a dry electrode film. In some embodiments, the method includes contacting the rollers with a dry electrode or dry electrode precursor material and imparting at least one force on the dry electrode or the dry electrode precursor powder with the surface hardened roller in order to form the dry electrode film.

The dry electrode or dry electrode precursor material can generally be any material effective as an electrode known to one of skill in the art. In some embodiments, the dry electrode or dry electrode precursor material are one of an anode or a cathode. In some embodiments, the anode or the cathode can each individually be a dry anode or cathode that is formed with substantially no solvent

Electrodes such as dry electrode can be implemented within electrical energy storage cells, which are widely used to provide power to electronic, electromechanical, electrochemical, and other useful devices. Such cells include batteries such as primary chemical cells and secondary (rechargeable) cells.

In some embodiments, the surface hardened rollers provide additional durability when rollers are used to impart force onto the electrode, for example when the roller is configured to turn faster or slower than the electrode or other sheet or web move over the roller.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of forming a dry electrode film, the method comprising:
contacting a surface hardened roller with a dry electrode or dry electrode precursor powder,
imparting at least one force on the dry electrode or the dry electrode precursor powder with the surface hardened roller in order to form the dry electrode film.

2. The method of claim 1, wherein the surface hardened roller includes a hardening layer of at least diamond like coating or tungsten carbide.

3. The method of claim 2, wherein the thickness of the hardening layer is about 1 μm to about 300 μm.

4. The method of claim 1, wherein the surface hardened roller includes at least one underlayer.

5. The method of claim 4, wherein the underlayer is comprised of one of tungsten carbide, a diamond like coating, copper, or chrome.

6. The method of claim 4, wherein the underlayer has a thickness of about 1 μm to about 50 μm.

7. The method of claim 1, wherein the surface hardened roller is at least one of a nip roller or a calendering roller.

8. A system comprising:
a roller comprising:
a hardening layer positioned on the surface of the roller.

9. The system of claim 8, wherein the hardening layer is comprised of one of tungsten carbide, chrome, or a diamond like coating.

10. The system of claim 8, wherein the thickness of the hardening layer is about 1 μm to about 300 μm.

11. The system of claim 8, further comprising an underlayer positioned between the surface of the roller and the hardening layer, wherein:
the underlayer is comprised of one of tungsten carbide, a diamond like coating, copper, or chrome.

12. The system of claim 11, wherein the underlayer has a thickness of about 1 μm to about 300 μm.
